(19) United States
(12) Patent Application Publication
(10) Pub. No.: US 2015/0332295 A1
(43) Pub. Date: Nov. 19, 2015

(54) Method of Forecasting Resource Demand

(71) Applicant: Mastercard International Incorporated, Purchase, NY (US)

(72) Inventors: Kenny Unser, Fairfield, CT (US); Jean-Pierre Gerard, Croton-on-Hudson, NY (US); Ed Lee, Scarsdale, NY (US)

(21) Appl. No.: 14/814,366

(22) Filed: Jul. 30, 2015

Related U.S. Application Data
(63) Continuation-in-part of application No. 14/183,220, filed on Feb. 18, 2014.

(51) Int. Cl. G06Q 30/02; G06Q 10/06

(52) U.S. Cl. CPC G06Q 30/0202; G06Q 10/067

(57) ABSTRACT

A system, method, and computer-readable storage medium configured to enable forecast resource demand based on accountholder or merchant-level behavior.

### RELATED APPLICATIONS

This application is a continuation-in-part of U.S. patent application Ser. No. 14/183,220, filed on Feb. 18, 2014 and entitled “Insurance Risk Modeling Method and Apparatus.”

### BACKGROUND

1. Field of the Disclosure

Aspects of the disclosure relate in general to modeling and forecasting resource demand. Aspects include an apparatus, system, method and computer-readable storage medium to enable forecast resource demand based on accountholder or merchant-level behavior.

2. Description of the Related Art

Resources are finite. There is simply a limit to the availability of water, oil, electricity, coal, concrete, wood or other natural or man-made resource. Consequently, management of resources is critical in society.

One of the components of resource management is the forecasting of resource demand. While there is a linear relationship between some resource demand and some resource consumption, it is difficult to forecast resource demand because there the relationships between many activities and resource usage are not clear.

For example, what is the relationship between the purchase of a microwave oven and water usage? Is there a relationship between increased consumption of groceries and the demand for natural gas? If there is a relationship, is it linear, or more complex?

In a different field, the use of payment cards, such as credit or debit cards, is ubiquitous in commerce. Typically, a payment card is electronically linked via a payment network to an account or accounts belonging to a cardholder. These accounts are generally deposit accounts, loan or credit accounts at an issuer financial institution. During a purchase transaction, the cardholder can present the payment card in lieu of cash or other forms of payment.

Payment networks process billions of purchase transactions by cardholders. The data from the purchase transactions can be used to analyze cardholder behavior. Typically, the transaction level data can be used only after it is summarized up to customer level. Unfortunately, the current transaction rolled-up processes are pre-knowledge based and does not result in transaction level models. For example, a merchant category code (MCC) or industry sector is to classify purchase transactions and summarize transactions in each category. This kind of summarization of information is a generic approach without using target information.

### SUMMARY

Embodiments include a system, apparatus, device, method and computer-readable medium configured to enable forecast resource demand based on accountholder or merchant-level behavior.

An apparatus embodiment includes a network interface, processor, and a non-transitory computer-readable storage medium. The network interface receives resource usage data associated with a customer. The resource usage data includes a resource usage attribute. The network interface receives transaction data regarding a plurality of transactions. The transaction data including transaction attributes. A processor generates a customer or merchant-location level target specific variable layer from the resource usage data, the transaction data and feedback from a resource usage model. The processor models resource usage with the customer or merchant-location level target specific variable layer to update the resource usage model. The resource usage model is saved to a non-transitory computer-readable storage medium.

### BRIEF DESCRIPTION OF THE DRAWINGS

FIG. 1 illustrates an embodiment of a system configured to enable forecast resource demand based on accountholder or merchant-level behavior.

FIG. 2 depicts a data flow diagram of a resource demand forecast apparatus configured to enable forecast resource demand based on accountholder or merchant-level behavior.

### DETAILED DESCRIPTION

One aspect of the disclosure includes the realization that an analysis engine embodiment described below can model and determine the correlation between consumer behavior and resource demands.

Another aspect of the disclosure includes the understanding that accountholder spending behavior is related to many types of resource demand, such as demand for water, electricity, and natural gas. In other words, analyzing accountholder spending or the amount of spending at a merchant location can provide a source of predictive information that may be used to assess resource demands when coupled with past usage data. For example, accountholder transaction data at a car wash coupled with car wash water usage may be used to create a model of future water usage. These and other similar accountholder/merchant purchases and expenditures may contain predictive information for the development of an accountholder transaction level resource usage level.

Embodiments of the present disclosure include a system, method, and computer-readable storage medium configured to enable forecast resource demand based on accountholder or merchant-level behavior. For the purposes of this disclosure, a payment account includes, but is not limited to checking account, savings account, credit cards, debit cards, prepaid cards, electronic checking, electronic wallet, or mobile device payments.

Embodiments may be used in a variety of potential resource management applications, including the water, electricity, natural gas, or any other resource.

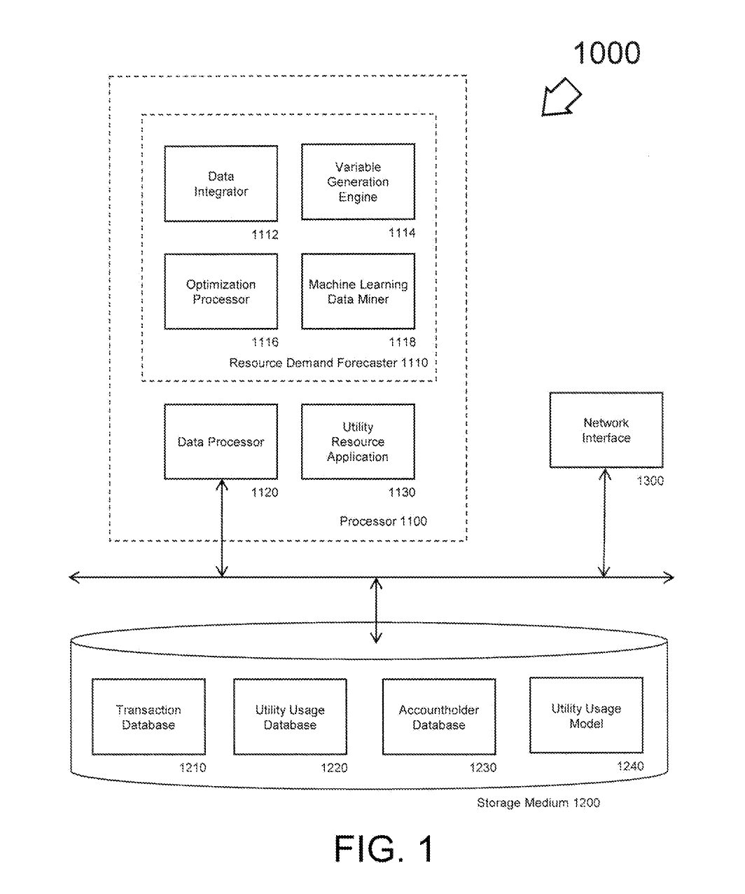

Embodiments will now be disclosed with reference to a block diagram of an exemplary resource forecast server 1000 of FIG. 1 configured to enable forecast resource demand based on accountholder or merchant-level behavior, constructed and operative in accordance with an embodiment of the present disclosure.

Resource forecast server 1000 may run a multi-tasking operating system (OS) and include at least one processor or central processing unit (CPU) 1100, a non-transitory computer-readable storage medium 1200, and a network interface 1300. An example operating system may include Advanced Interactive Executive (AIX™) operating system, UNIX operating system, or LINUX operating system, and the like.

Processor 1100 may be any central processing unit, microprocessor, micro-controller, computational device or circuit known in the art. It is understood that processor 1100 may communicate with and temporarily store information in Random Access Memory (RAM) (not shown).

As shown in FIG. 1, processor 1100 is functionally comprised of a resource demand forecaster 1110, a utility resource application 1130, and a data processor 1120.

Resource demand forecaster 1110 is a component configured to enable forecast resource demand based on accountholder or merchant-level behavior. Resource demand forecaster 1110 may further comprise: a data integrator 1112, variable generation engine 1114, optimization processor 1116, and a machine learning data miner 1118.

Data integrator 1112 is an application program interface (API) or any structure that enables the resource demand forecaster 1110 to communicate with, or extract data from, a database.

Variable generation engine 1114 is any structure or component capable of generating customer level target-specific variable layers from given transaction level data.

Optimization processor 1116 is any structure configured to receive target variables from a transaction level model defined from a business application and refine the target variables.

Machine learning data miner 1118 is a structure that allows users of the resource demand forecaster 1110 to enter, test, and adjust different parameters and control the machine learning speed. In some embodiments, machine learning data miner uses decision tree learning, association rule learning, neural networks, inductive logic programming, support vector machines, clustering, indexing, regression, decision tree logic such as CHi-squared Automatic Interaction Detection (CHAID), autoregressive moving average (ARIMA), time series techniques, Bayesian networks, reinforcement learning, representation learning, similarity and metric learning, spare dictionary learning, and ensemble methods such as random forest, boosting, bagging, and rule ensembles, or a combination thereof.

Utility resource application 1130 is an application that utilizes resource demand forecasts based on accountholder or merchant-level behavior produced by resource demand forecaster 1110. In some embodiments, utility resource application 1130 utilizes a network interface 1300 to communicate resource demand forecasts to utilities or other resource providers or managers.

Data processor 1120 enables processor 1100 to interface with storage medium 1200, network interface 1300 or any other component not on the processor 1100. The data processor 1120 enables processor 1100 to locate data on, read data from, and write data to these components.

These structures may be implemented as hardware, firmware, or software encoded on a computer-readable medium, such as storage medium 1200. Further details of these components are described with their relation to method embodiments below.

Network interface 1300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1300 allows resource forecast server 1000 to communicate with vendors, accountholders, issuer financial institutions and/or financial securities brokerages.

Computer-readable storage medium 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 1200 may be remotely located from processor 1100, and be connected to processor 1100 via a network such as a local area network (LAN), a wide area network (WAN), or the Internet.

In addition, as shown in FIG. 1, storage medium 1200 may also contain a transaction database 1210, utility usage database 1220, accountholder database 1230 and a utility usage model 1240. Transaction database 1210 is configured to store records of payment account transactions. Utility usage database 1220 is configured to known resource usage at locations including accountholder residences and places of business. Accountholder database 1230 is configured to store accountholder information and transactions information related to specific accountholders. In some embodiments, accountholder database 1230 may be the transaction database 1210 organized by accountholder information. A utility usage model 1240 is a resource usage model for an accountholder or merchant location based on accountholder transactions. In some embodiments, an individual accountholder's transactions may be compared to transactions made by other accountholder transactions.

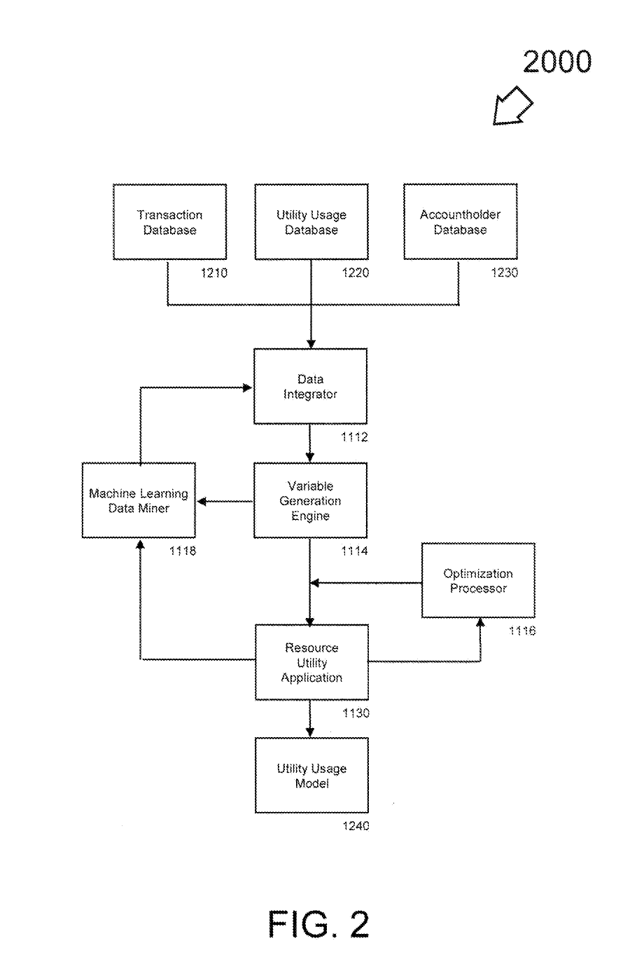

It is understood by those familiar with the art that one or more of these databases 1210-1240 may be combined in a myriad of combinations. The function of these structures may best be understood with respect to the data flow diagram of FIG. 2, as described below.

We now turn our attention to the method or process embodiments of the present disclosure described in the data flow diagram of FIG. 2. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 2 is a data flow diagram of a resource forecast server method 2000 to enable forecast resource demand based on accountholder or merchant-level behavior, constructed and operative in accordance with an embodiment of the present disclosure. The resulting utility usage model 1240 may be used in resource usage assessment to forecast customer resource usage for a variety of utility resource application 1130 categories.

Method 2000 is a batch method that enables forecasting and modeling of resource use based on customer and merchant-level payment account purchases.

As shown in FIG. 2, data integrator 1112 receives data from a transaction database 1210, utility usage database 1220, and accountholder database 1230. The data may be filtered by time range, depending upon data availability or desirability.

The accountholder's individual transaction data may come from a transaction database 1210, an accountholder database 1230 or both. The accountholder's individual transaction data includes a transaction entry for each financial transaction performed with a payment account. Each transaction entry may include, but is not limited to a transaction data, customer information (such as an anonymized customer account identifier, customer geography, customer type, and customer demographics), merchant details (name, geographic location, line of business, and firmographics), purchase channel (on-line versus in-store transaction), product or service stock-keeping unit (SKU), and transaction amount.

A utility usage database 1220 provides external (non-financial transaction-based) data sources for determining resource usage. The utility usage database 1220 may be populated using publically available data on resource utilization at the merchant level to establish relationship with transaction data. These sources include, but are not limited to: U.S. Energy Information Administration (EIA) estimates for monthly and annual energy consumption by the residential sector and the commercial sector, EIA Energy data on consumption by the commercial sector (including energy consumption for street and other outdoor lighting, and for water and sewage treatment), and EIA estimates for heating, ventilation, cooling, and lighting in manufacturing facilities in specific years.

These sources may include resource usage data including dimensions (such as geography, industry, industry versus customer utilization) or metrics (such as rate of utilization change, absolute level of utilization and utilization per capita). Examples of such data include, but are not limited to: resource utilization at a transaction level (ex. gallons per car wash transaction), utility pricing information (ex. cost per kilowatt), type of goods sold by the merchant (ex. farmed goods, manufactured metals, manufactured plastics), origin of goods sold by merchant (local vs. domestic vs. international), weather data (ex. inches of rain received), and resources used to manufacture goods (ex. water utilization of farmed goods).

Data integrator 1112 provides the data to the variable generation engine 1114. Variable generation engine 1114 produces a variable layer with transaction attribute variables to support the resource demand forecast analysis.

Statistical techniques are used to derive resource usage insights, based on transaction attribute variables. The statistical methods used to establish linkage with transactional data may include correlation tests, indexing, regression, decision tree logic and clustering.

For any utility resource application 1130 with at least one transaction attribute of interest, Xᵢ(A; t, l) can denote a transaction attribute variable at transaction level belonging to an account A, by transaction time stamp t, and transaction location l. For example, X can be payment amount or any transaction related attribute, and V_{A}(x) can be a summarized variable at the customer level which can be any function of original transaction attribute x for a given utility usage model 1240, designated as target T.

Once generated, the transaction attribute of interest is provided to the utility resource application 1130 and the machine learning data miner 1118. The machine learning data miner 1118 receives inputs from both the variable generation engine 1114 and the utility resource application 1130 to refine the utility usage model 1240. Machine learning data miner 1118 starts with dozens of attributes of the transaction data, and computes the implicit relationships of these attributes and the relationship of the attributes to the utility resource application 1130. The machine learning data miner 1118 derives from or transforms these attributes to their most useful form, then selects the variables for the variable generation engine 1114.

Utility resource application 1130 also feeds information to optimization processor 1116. The optimization process happens after the variables are created by modeling processes:

$$V ( x ) {}^{Model} T .$$

Optimization processor 1116 maximizes the correlation of the generated variables V with the target T by searching optimal mapping [symbol] and roll-up function [symbol] :

$$ℐ \{ {X}_{i} ( A ; t , ℒ ) \} {}^{Specific ℐ and ℒ to Maximize relevant V \to T} {V}_{A} ( x , T )$$

The searching space for the optimal mapping and functions is large, and the Optimization processor 1116 may test the searching process with a limited domain. For example, one simplified approach is to fix the function dimension [symbol] = [symbol] , and searching the optimal mapping [symbol] .

In essence, the optimization processor 1116 learns from vast transactional data, explores target relevant data dimensions, and generates optimal customer level variable summarization rules automatically. The optimization processor 1116 is similar to the machine learning data miner 1118, but the difference is that optimization processor 1116 is working on the data that has been aggregated to the account level. The final utility usage model 1240 is implemented on each account for actions to be taken upon.

The optimization processor 1116 starts with selected variables (attributes) of each account (customer) and applies the statistical analysis to reduce the list of variables that appear to be related to various investment ratings and outcomes based on the customer's transaction data. The optimization may be accomplished by computing the relationship of these variables to the utility resource application 1130, and derives from or transforms these variables to their most useful form, applying the analytic phase to a broad universe of accountholders.

The utility resource application 1130 may then transmit or display a customer resource usage assessment for an accountholder based on their utility usage model 1240. In some embodiments, when an accountholder has opted into reporting from a utility resource application 1130, the utility resource application 1130 electronically communicates a message to a utility or other resource provider via the network interface 1300. The message includes a customer identifier associated with the accountholder, and the customer resource usage assessment for the accountholder. The customer resource usage assessment for the accountholder may be a rate of utility usage change, absolute level of utilization, or utilization per capita.

The feedback from optimization processor 1116 and machine learning data miner 1118 provides a machine learning approach for transactional data to customer resource usage optimization problems.

### Example Embodiments

This section describes sample resource usage applications for various embodiments.

Embodiments can be used to augment known data, such as water usage estimates for a specific business. Suppose, for example, a car wash has been in business for a year. In the past, civic planners could have used a general estimate of water usage when they approved the original zoning. Such an estimate was typically based on the car wash's business plan estimates and some other assumptions.

Now that the business has been in business for a year, the same civic planners are looking to enhance their estimation process using in in market data.

Civic planners (usually a governmental entity) provide an embodiment actual water usage data for the car wash. Historical water usage data is collected for the car wash, and, in some embodiments, for one or more car washes. A payment network provides the embodiment seasonality and growth information intended to augment known water usage data. Historical transaction data for car washes is summarized with known water usage by number of transactions per day. The summary may be performed on the total number of overall transactions, by transaction amount bucket (ex. $10 to <$20, $20 to <$30), or by integrating the transaction count data with historical water usage data to determine the amount each transaction amount bucket (a proxy for the service type—undercarriage wash, basic wash, etc.) contributes to water usage.

The embodiment calculates the factors that create a direct association between a car wash transaction and the amount of water consumed by the car wash, storing the calculations in a database. The same transaction count data is computed for one or more car washes with unknown water utilization by apply the factors stored in the factors database to the spend data, and producing an estimate of water utilization for each car wash. The estimates are stored in a utility usage model used to deliver the forecasts to the civic planners or other governmental entity.

Using the in-market, data-driven projections of water usage provided by the embodiment, the civic planners are able to make a more informed decisions about zoning a second location for the car wash.

Some embodiments use internal and external data to make a resource usage forecast. In such an embodiment, the embodiment uses industry information about resource utilization during manufacturing and sales information from transaction data to estimate changes in resource utilization based on demand.

Alternate embodiments only use internal data. Aggregate utility bill payment information to extrapolate per capita resource utilization based on geography, commercial vs. consumer, and other factors.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A resource usage assessment method comprising:
receiving resource usage data associated with a customer via a network interface, the resource usage data including a resource usage attribute;
receiving transaction data regarding a plurality of transactions via the network interface, the transaction data including transaction attributes;
generating, via a processor, a customer or merchant-location level target specific variable layer from the resource usage data, the transaction data and feedback from a resource usage model;
modeling, via the processor, resource usage with the customer or merchant-location level target specific variable layer to update the resource usage model;
saving the resource usage model to a non-transitory computer-readable storage medium.

2. The resource usage assessment method of claim 1, wherein the transaction attribute includes a transaction account, a transaction time, and merchant details.

3. The resource usage assessment method of claim 2, wherein the resource usage data includes a rate of resource utilization change absolute level of resource utilization, or resource utilization per capita.

4. The resource usage assessment method of claim 3, wherein the generating the customer or merchant-location level target specific variable layer comprises:
summarizing or averaging the transaction attribute at a customer or merchant-location level with the processor.

5. The resource usage assessment method of claim 4, further comprising:
forecasting, with the processor, a customer resource usage assessment based on the resource usage model.

6. The resource usage assessment method of claim 5, further comprising:
transmitting a message containing the customer resource usage assessment to a utility via the network interface.

7. The resource usage assessment method of claim 5, further comprising:
transmitting a message containing the customer resource usage assessment to a governmental entity via the network interface.

8. A resource usage assessment apparatus comprising:
a network interface configured to receive resource usage data associated with a customer via a network interface, the resource usage data including a resource usage attribute, and to receive transaction data regarding a plurality of transactions via the network interface, the transaction data including transaction attributes;
a processor configured to generate a customer or merchant-location level target specific variable layer from the resource usage data, the transaction data and feedback from a resource usage model, configured to model resource usage with the customer or merchant-location level target specific variable layer to update the resource usage model;
non-transitory computer-readable storage medium configured to save the resource usage model.

9. The resource usage assessment apparatus of claim 8, wherein the transaction attribute includes a transaction account, a transaction time, and merchant details.

10. The resource usage assessment apparatus of claim 9, wherein the resource usage data includes a rate of resource utilization change, absolute level of resource utilization, or resource utilization per capita.

11. The resource usage assessment apparatus of claim 10, wherein the generating the customer or merchant-location level target specific variable layer comprises:
summarizing or averaging the transaction attribute at a customer or merchant-location level with the processor.

12. The resource usage assessment apparatus of claim 11, wherein the processor is further configured to forecast a customer resource usage assessment based on the resource usage model.

13. The resource usage assessment apparatus of claim 12, wherein the network interface is further configured to transmit a message containing the customer resource usage assessment to a utility.

14. The resource usage assessment method of claim 12, wherein the network interface is further configured to transmit a message containing the customer resource usage assessment to a governmental entity.

15. A non-transitory computer-readable storage medium encoded with data and instructions, when executed by a computing device the instructions causing the computing device to:
receive resource usage data associated with a customer via a network interface, the resource usage data including a resource usage attribute;
receive transaction data regarding a plurality of transactions via the network interface, the transaction data including transaction attributes;
generate, via a processor, a customer or merchant-location. level target specific variable layer from the resource usage data, the transaction data and feedback from a resource usage model;
model, via the processor, resource usage with the customer or merchant-location level target specific variable layer to update the resource usage model;
save the resource usage model to a non-transitory computer-readable storage medium.

16. The non-transitory computer-readable storage medium of claim 15, wherein the transaction attribute includes a transaction account, a transaction time, and merchant details.

17. The non-transitory computer-readable storage medium of claim 16, wherein the resource usage data includes a rate of resource utilization change, absolute level of resource utilization, or resource utilization per capita.

18. The non-transitory computer-readable storage medium of claim 17, wherein the generating the customer or merchant-location level target specific variable layer comprises:
summarizing or averaging the transaction attribute at a customer or merchant-location level with the processor.

19. The non-transitory computer-readable storage medium of claim 18, further comprising:
forecasting, with the processor, g a customer resource usage assessment based on the resource usage model.

20. The non-transitory computer-readable storage medium of claim 19, wherein the network interface is further configured to transmit a message containing the customer resource usage assessment to a utility.
